(19) United States
(12) Patent Application Publication
(10) Pub. No.: US 2025/0230730 A1
(43) Pub. Date: Jul. 17, 2025

(54) FRAME FOR USE SUBSEA

(71) Applicant: BAKER HUGHES ENERGY TECHNOLOGY UK LIMITED, Bristol (GB)

(72) Inventors: Gabriele CARBONI, Rufina (IT); Pietro CASTELLI, Firenze (IT)

(21) Appl. No.: 18/852,868

(22) PCT Filed: Apr. 4, 2023
(86) PCT No.: PCT/EP2023/025157

§ 371 Date: Sep. 30, 2024

(30) Foreign Application Priority Data
Apr. 5, 2022 (IT) 102022000006731

(51) Int. Cl. E21B 41/00; B33Y 80/00; E21B 17/02

(52) U.S. Cl. CPC E21B 41/0007; B33Y 80/00; E21B 17/02

(57) ABSTRACT

A frame, for example a carrier frame, for use in a subsea environment. The frame may include a hollow body configured to receive a plurality of service lines. The hollow body is made up of two or more parts made of a polymer. A method of manufacturing a frame is also provided in which the two or more parts of the hollow body are made by additive manufacturing.

### TECHNICAL FIELD

The present disclosure relates to a frame for use in a subsea environment, for example when connecting a flying lead to a subsea installation.

### BACKGROUND

In various subsea applications including the field of subsea oil and gas production, and the field of subsea sCO₂ re-injection, there is a need to provide connections between different structures or installations. These connections include connections for at least power delivery, control signals and product delivery. In various examples, hydraulic fluids and/or other chemicals are required to be sent from a first subsea structure to either a second subsea structure or to a structure located above the surface. To achieve this, a number of service lines, for example hydraulic cables, may be formed into a bundle and connected between first and second structures.

Typically, service lines between adjacent Oil & Gas Production facilities on the seabed (for hydraulic fluid or for injected chemical supplies) are implemented using a connector at each end of a relatively flexible bundle of service lines. One example of such a connector is a Multi Quick Connection flying plate, in which the service lines may be joined to tubes within the flying plate. A carrier frame may be provided to withstand loads resulting from the bundle of service lines, e.g. a weight force due to the bundle.

The present disclosure provides a simplified frame, which is less expensive to manufacture and which is suitable for use subsea in any of the applications outlined above.

### SUMMARY

From a first aspect of the disclosure, a frame for use in a subsea environment is provided, the frame comprising:

a hollow body configured to receive a plurality of service lines, wherein the hollow body is made up of two or more parts made of a polymer.

In any example of the disclosure, the two or more parts of the frame may be made by additive manufacturing.

In any example of the disclosure, the frame may be a carrier frame.

In any example of the disclosure, the frame may comprise a first part and a second part. In some examples, the first part may be configured to be joined to the second part to form a hollow body which surrounds and protects a length of the service lines.

In some examples, the first part may comprise a first section and a second section, wherein the first section and the second part may each be substantially semi-circular in cross section and may be configured to form a substantially cylindrical hollow body when joined together.

In some examples, each of the first section and the second part may comprise a first flange and a second diametrically opposite flange extending radially outwardly therefrom, and the first and second flanges of the first section may be configured to abut against the first and second flanges of the second part when the frame is assembled.

In any example of the disclosure, the frame may be configured to receive a connector for connecting the plurality of service lines to a subsea installation.

In any example of the disclosure, the second section of the first part may form a cap for receiving an end of the connector.

In any example of the disclosure, one or more openings may be provided in the frame to allow water to flow into the frame when assembled.

From a further aspect, the disclosure may provide a service line connection system for use in a subsea environment and comprising:
a plurality of service lines;
a subsea installation;
a connector connected to the plurality of service lines and configured to connect the plurality of service lines to the subsea installation; and
a frame as set out above, wherein the plurality of service lines extend through the frame.

In any example of the disclosure, the connector may be received in the frame.

In any example of the disclosure, the service line connection system may further comprise a tubing surrounding the plurality of service lines.

From a still further aspect, the present disclosure provides a method of producing a frame for use in a subsea environment, the frame comprising:
a hollow body configured to receive a plurality of service lines, wherein the hollow body is made up of two or more parts made of a polymer, the method comprising forming the two or more part of the hollow body by additive manufacturing.

Although certain advantages are discussed below in relation to the features detailed above, other advantages of these features may become apparent to the skilled person following the present disclosure.

### BRIEF DESCRIPTION OF THE DRAWINGS

One or more non-limiting examples will now be described, by way of example only, and with reference to the accompanying figures in which:

FIG. 1 is a schematic view showing a system for subsea applications;

FIG. 2 is a view of a subsea structure with a hydraulic flying lead connected thereto;

FIG. 3 is an exploded view of a part of a system according to an example of the disclosure; and

FIG. 4 is a perspective view of the part of the system of FIG. 3 when assembled.

### DETAILED DESCRIPTION

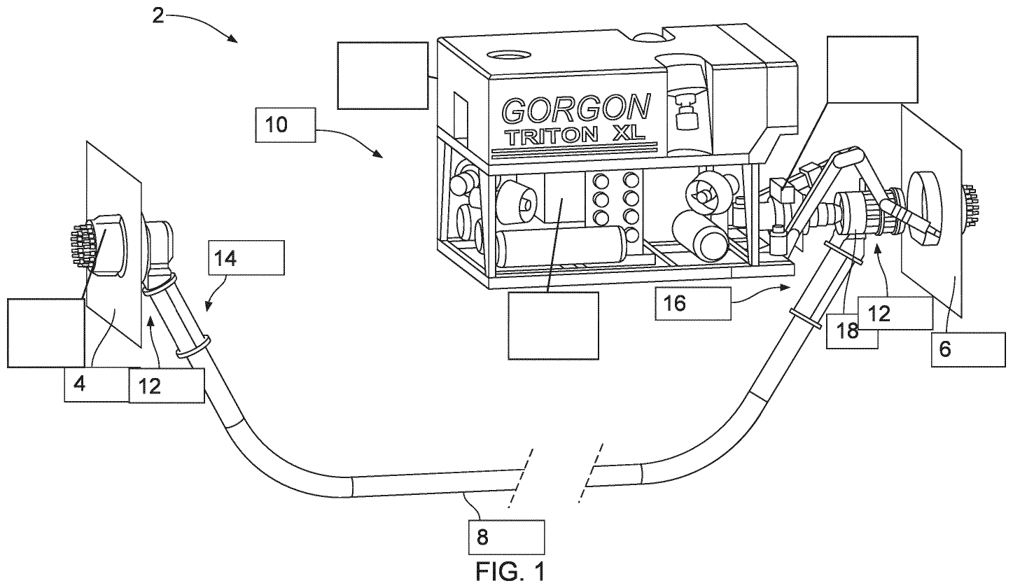

A system 2 suitable for use in various subsea applications is shown in FIG. 1. The various subsea applications may include but are not limited to oil and gas production and subsea sCO₂ re-injection.

As shown in FIG. 1, a first subsea installation 4 (only part of which is shown in FIG. 1) can be connected via various service lines extending in a bundle from the first subsea installation 4 to a second subsea installation 6 (only part of which is shown in FIG. 1). It will be appreciated that in FIG. 1, the service lines are shown as connected to the first subsea installation 4 and disconnected from the second subsea installation 6. Each of the first and second subsea installations 4, 6 may be any suitable subsea structure such as, for example, a subsea distribution unit (SDU), a Christmas tree or an Umbilical Termination Assembly (UTA).

As shown in FIG. 1, the bundle of service lines may be enclosed within a tubing 8 which extends along the axial length of the bundle to form a flying lead, for example a hydraulic flying lead (HFL) in an example where the service lines are hydraulic cables. In various examples, the tubing may be made from a flexible material, for example a flexible plastic tubing or a composite tubing.

As shown in FIG. 1, the flying lead may be connected with and disconnected from subsea structures using a Remote Operated Vehicle (ROV) 10. First and second connectors 12 (for example, flying plates or Multi Quick connection flying plates) form the respective first and second axial ends 14, 16 of the flying lead. The connectors 12 are configured to connect each separate service line within the flying lead to a respective service line in the respective first and second subsea installations 4, 6. The present disclosure provides a frame 18 which can be mounted onto an axial end 14, 16 of the tubing 8 so as to protect the service lines of the bundle from external loads. In any example and as shown in the drawings, the frame 18 may be a carrier frame which mounts each flying plate 12 to a respective axial end of the tubing 8.

Any suitable number of flying leads could be connected to a singles subsea structure. For example, the subsea structure may for example have four separate ports for connecting to each of four separate flying leads. It will be understood that each flying lead could include any suitable number of service lines.

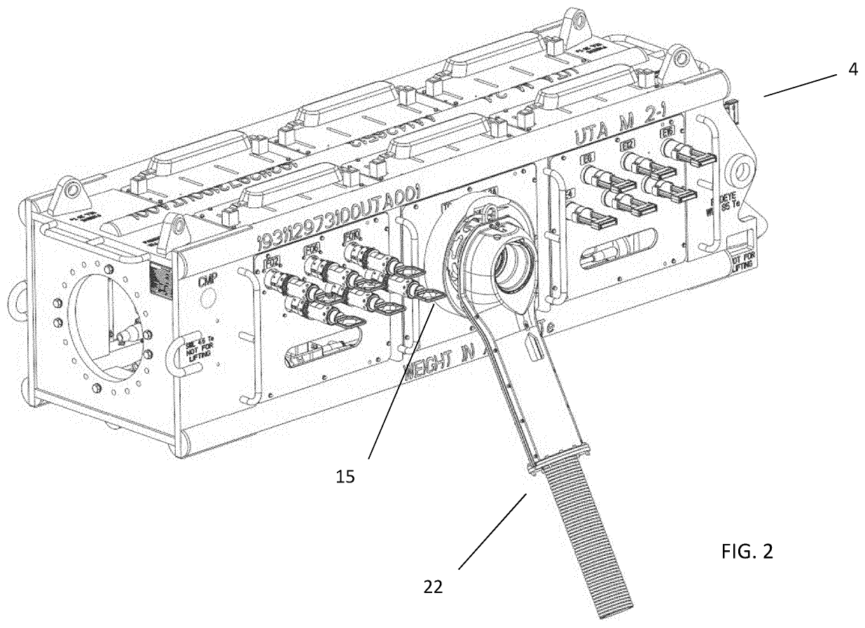

In the example shown in FIG. 2 however, a single flying lead 22 may be connected to a UTA (the subsea structure 4) via a port 15 (for example a fixed plate).

It will be understood that the service lines within a bundle connecting subsea structures according to the disclosure could be hydraulic cables for hydraulic fluid or could equally well be service lines or cables for carrying chemicals other than hydraulic fluid. Further, different service lines within the bundle could of course carry different chemicals and fluids as required for any particular application. For example, some service lines within a bundle could carry hydraulic fluids and other service lines within the same bundle could carry other fluids. In further examples, the service lines may also be or include optical and/or electrical cables.

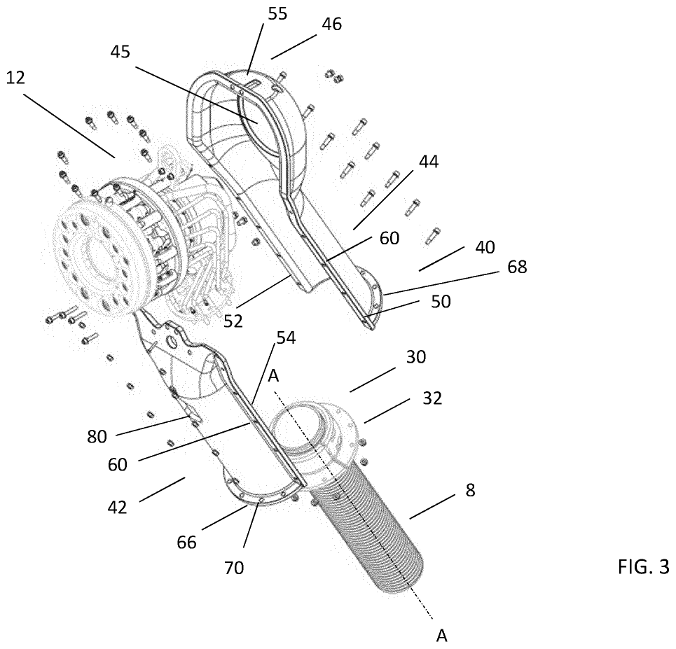

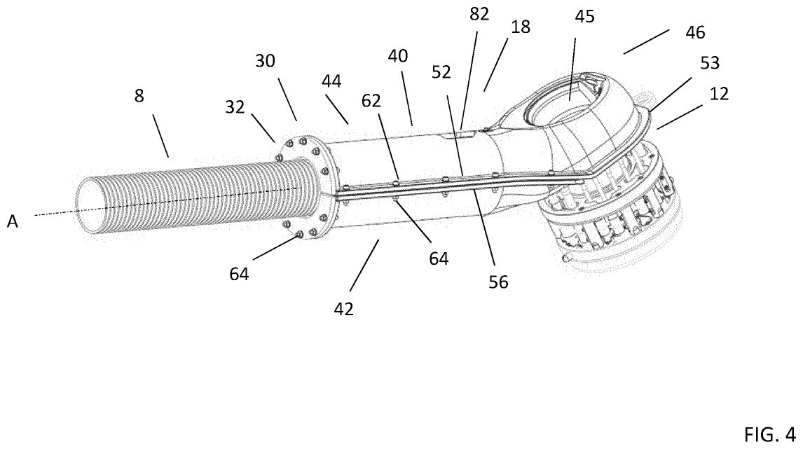

A frame according to an example of the disclosure will now be described in further detail and is shown in the exploded perspective view of FIG. 3 and in the assembled perspective view of FIG. 4. It will be understood that, for the sake of clarity, the service lines which are provided inside the tubing 8 are not shown. The tubing 8 may be of a standard type extending along a longitudinal axis A-A.

As seen in FIG. 3, in some examples of the disclosure, a sealing member 30 comprising a flange 32 may be provided to fit around the outer circumference of the tubing 8 such that the flange 32 extends around and radially outwardly from the tubing 8. In other examples, which are not shown here, no sealing member of the type shown in FIG. 3 is provided.

A connector 12 is connected to each of the service lines located inside the tubing 8. The connector 12 may comprise a flying plate as described above and each of the tubes of the flying plate may be connected with a respective service line. The flying plate 12 is configured for connecting with a fixed plate (not shown) assembled onto a subsea installation or other suitable part of a system.

A frame 18 is provided which will now be described in further detail. The frame 18 is formed from two or more parts so that it can be mounted around a length of the bundle of service lines to extend from the connector 12. In the example of FIGS. 3 and 4, the frame 18 is formed of a first part 40 and a second part 42. The first part 40 may be one integral part and may comprise a first section 44 and a second section 46. The first section 44 is configured to be joined with the second part 42 to form a substantially cylindrical hollow body in the example shown which surrounds and protects the service lines when in situ. Various different configurations of the first and second parts 40, 42 would be possible. For example, the hollow body formed by the parts may not be cylindrical in some examples of the disclosure. In the example shown however, the first section 44 and the second part 42 are each substantially semi-circular in cross section. In other words, the substantially cylindrical hollow body is split diametrically into the first section 44 and the second part 42.

The first section 44 and the second part 42 could be configured to be joined together by any suitable mechanism. In various examples and as shown in FIGS. 3 and 4, each of the first section 44 and the second part 42 may comprise a first flange and a second diametrically opposite flange extending radially outwardly therefrom. The first and second flanges 50, 52 of the first section 44 may be configured to abut against the first and second flanges 54, 56 of the second part 42 when the frame 18 is assembled around the service line bundle. As seen in FIG. 4, the respective flanges 50, 52, 54, 56 can extend axially along the respective first section 44 and the second part 42. One or more corresponding apertures 60 may be formed through the respective flanges 50, 52, 54, 56 and a bolt 62 or other suitable fixing (for example a rivet) can be placed through each aperture 60 when the frame 18 is assembled. The bolt 62 may be secured in place by a nut 62 as seen in FIG. 4.

In the example of FIG. 3, each of the first part 40 and the second part 42 also comprise a further flange 66, 68 extending radially outwardly therefrom at an axial end thereof and extending around the perimeter of the section in a circumferential direction. The further flanges 66, 68 may be configured to abut against the flange 32 of the sealing member 30 when the frame 18 is assembled around the service line bundle. One or more corresponding apertures 70 may be formed through the respective further flanges 66, 68 and the flange 32 and a bolt 62 or other suitable fixing (for example a rivet) can be placed through each aperture 70 when the frame 18 is assembled. The bolt 62 may be secured in place by a nut 64 as seen in FIG. 4.

In an alternative arrangement, in which no sealing member 30 of the type shown is provided, an annular seal (not shown) may be provided which extends between the outer surface of the tubing 8 and the inner surface of the frame 18.

In any example of the disclosure, the fixing (for example the nuts and bolts described above) may be made from a corrosion resistant material such as Super Duplex Stainless Steel.

As described above, in the example shown, the first part 40 of the frame 18 comprises a first section 44 and a second section 46. The second section 46 forms an axial extension of the first section 44 and is configured to surround part of the connector 12. In the example shown, the second section 46 may form a cap which extends over and around a first end of the connector 12 such that the connector 12 is held in place within the frame 18 when the frame is assembled to the tubing 8 and the connector 12.

As seen for example in FIG. 3, the connector 12 may be substantially circular in axial cross section and the second section 46 may be formed so as to receive the connector 12. Thus, the second section 46 may in some examples comprise a cap (for example a part of a hemisphere) extending outwardly from the first section 44. In some examples and as shown in FIG. 3, the part of the second section furthest from the longitudinal axis A-A may be cut away to form an opening 45 in the first part of the frame 18. In any example of the disclosure, the opening 45 may be substantially circular and may be axially aligned with the connector 12 when the connector 12 is positioned within the frame 18.

A third flange 53 may extend along an edge of the second section 46 to extend radially outwardly therefrom and, in some examples, may join the first flange 50 to the second flange 52. Further apertures (not shown) may be formed in the third flange 53 through which fasteners such as nuts and bolts (not shown) may pass to join the third flange 53 to the connector 12 in use.

In some further examples, a planar or flat portion 55 may be formed in an axial end of the cap formed by the second section 46.

In any example of the disclosure, the frame 18 is made from a polymeric material such as polypropylene for example. This may provide additional buoyancy to the flying lead and connector 12 when assembled thereon which may be useful in various subsea applications. The use of a polymeric material also significantly reduces the time and costs associated with manufacturing and installing a frame according to the disclosure in a subsea system. In comparison to the use of a polymer, if a metal were to be used to manufacture the frame, different components thereof would need to be welded together, resulting in the need to use expensive and time consuming non-destructive testing (NDT) to check the structural integrity of the welds. A further advantage of forming the frame from a polymer is that the frame may then not be vulnerable to corrosion, thus reducing the need for cathodic protection in a subsea environment and potentially prolonging the service life of the frame.

A further advantage of the frame according to at least some examples of the disclosure is that the frame may be sufficiently stiff to provide protection and prevent undesired deformation of the fittings linking the service lines of the flying lead to the tubes in a flying plate. Such deformations could result for example in undesired leakage of fluid from the service lines into the surrounding sea or environment. This could result in undesirable pollution from the fluids travelling through the flying lead.

In some examples of the disclosure, the frame may be made by additive manufacturing. This may allow the parts of the frame to be manufactured quickly to a very high accuracy and at low expense.

It will be understood that various components provided within the frame 18 in use may be metallic and so may be vulnerable to corrosion. To enhance cathodic protection of these components therefore, one or more openings or slots may be provided in the frame 18 to allow water to flow into the frame 18 when assembled. In various examples such as that shown in FIGS. 3 and 4, a first opening 80 may be formed in the second part 42 of the frame 18 and a second opening 82 may be formed in the first part 40 of the frame 18.

It will be appreciated that the example systems shown and described herein have a number of advantages over the prior art systems. Specifically, by manufacturing the frame from a polymeric material, the manufacturing and maintenance costs thereof may be significantly reduced. Further, the frame may be more easily formed in any desired shape required for a particular system. Still further, there is no need to provide anodes for cathodic protection of the frame as would be needed if the frame were made from steel or another such metal.

While the disclosure has been described in detail in connection with only a limited number of examples, it should be readily understood that the disclosure is not limited to such disclosed examples. Rather, the disclosure can be modified to incorporate any number of variations, alterations, substitutions or equivalent arrangements not heretofore described, but which are commensurate with the scope of disclosure. Additionally, while various examples of the disclosure have been described, it is to be understood that aspects of the disclosure may include only some of the described examples. Accordingly, the disclosure is not to be seen as limited by the foregoing description, but is only limited by the scope of the appended claims.

1. A frame for use in a subsea environment, the frame comprising: a hollow body configured to receive a plurality of service lines, wherein the hollow body is made up of two or more parts made of a polymer.

2. The frame as claimed in claim 1, wherein the two or more parts of the frame are made by additive manufacturing.

3. The frame as claimed in claim 1, wherein the frame is a carrier frame.

4. The frame as claimed in claim 1, wherein the frame comprises a first part and a second part.

5. The frame as claimed in claim 4, wherein the first part is configured to be joined to the second part to form a hollow body which surrounds and protects a length of the service lines.

6. The frame as claimed in claim 4, wherein the first part comprises a first section and a second section, wherein the first section and the second part are each substantially semi-circular in cross section and are configured to form a substantially cylindrical hollow body when joined together.

7. The frame as claimed in claim 4, wherein each of the first section and the second part comprise a first flange and a second diametrically opposite flange extending radially outwardly therefrom, and wherein the first and second flanges of the first section are configured to abut against the first and second flanges of the second part when the frame is assembled.

8. The frame as claimed in claim 1, wherein the frame is configured to receive a connector for connecting the plurality of service lines to a subsea installation.

9. The frame as claimed in claim 8, wherein the frame forms a cap for receiving an end of the connector.

10. The frame as claimed in claim 1, wherein one or more openings are provided in the frame to allow water to flow into the frame when assembled.

11. A service line connection system for use in a subsea environment and comprising: a plurality of service lines; a subsea installation; a connector connected to the plurality of service lines and configured to connect the plurality of service lines to the subsea installation; and the frame as claimed in claim 1, wherein the plurality of service lines extend through the frame.

12. The service line connection system as claimed in claim 11, wherein the connector is received in the frame.

13. The service line connection system as claimed in claim 11, further comprising a tubing surrounding the plurality of service lines.

14. A method of producing a frame for use in a subsea environment, the frame comprising: a hollow body configured to receive a plurality of service lines, wherein the hollow body is made up of two or more parts made of a polymer, the method comprising forming the two or more parts of the hollow body by additive manufacturing.
